(19) United States
(12) Patent Application Publication
(10) Pub. No.: US 2012/0169937 A1
(43) Pub. Date: Jul. 5, 2012

(54) IMAGE PROCESSING APPARATUS AND IMAGE PROCESSING METHOD

(75) Inventor: Tetsuji Saito, Kawasaki-shi (JP)

(73) Assignee: CANON KABUSHIKI KAISHA, Tokyo (JP)

(21) Appl. No.: 13/333,194

(22) Filed: Dec. 21, 2011

(30) Foreign Application Priority Data
Jan. 5, 2011 (JP) 2011-000672
Nov. 2, 2011 (JP) 2011-241099

(51) Int. Cl. H04N 5/14

(52) U.S. Cl. 348/700

(57) ABSTRACT

An image processing apparatus comprises a motion vector detection unit that detects a motion vector from each frame of inputted moving image data, for each block, a total motion vector calculation unit that calculates, for each block, a total motion vector being a total value of the motion vectors in a time direction of a frame group corresponding to a first period, a total stillness amount calculation unit that calculates, for each frame, a value based on the number of total motion vectors each having a magnitude of not more than a first predetermined value as a total stillness amount, and an extraction unit that extracts moving image data composed of a frame group including a frame having the calculated total stillness amount of not less than a first threshold at a rate not less than a predetermined rate.

### BACKGROUND OF THE INVENTION

1. Field of the Invention

The present invention relates to an image processing apparatus and an image processing method.

2. Description of the Related Art

Recently, in a display, an increase in image quality and increases in resolution and definition such as 4K×2K have been promoted, and it has become possible to give realistic sensation higher than that of Full-HD to viewers. Hereafter, the demand for an image capable of making full use of characteristics of such display, i.e., an image capable of giving higher realistic sensation to the viewers is expected to grow. In order to give higher realistic sensation to the viewers, a moving image is more suitable than a still image. However, in the case of a moving image in which a movement is extremely vigorous, the viewers cannot recognize details of the image so that the viewers cannot feel high definition. Consequently, in order to give higher realistic sensation to the viewers, a monotonous moving image in which the movement is not very vigorous is suitable.

Japanese Patent Application Laid-open No. 2003-283966 discloses a technology in which moving image data is divided into a plurality of scenes on the basis of a feature amount, and an identical scene is detected by comparing the feature amount in a scene with the feature amount of one or a plurality of scenes at positions before the scene.

### SUMMARY OF THE INVENTION

However, in the technology disclosed in Japanese Patent Application Laid-open No. 2003-283966, since the scene having the difference in the feature amount between the scenes within a predetermined threshold is detected as the identical scene, it is not possible to detect only a scene capable of giving high realistic sensation to viewers.

A present invention provides a technology capable of extracting only moving image data of a scene capable of giving high realistic sensation to viewers from inputted moving image data.

The present invention in its first aspect provides an image processing apparatus for extracting moving image data of a desired scene from inputted moving image data, comprising:

a motion vector detection unit that detects a motion vector from each frame of the inputted moving image data, for each block obtained by dividing the frame;

a total motion vector calculation unit that calculates, for each block of the frame, a total motion vector being a total value of the motion vectors in a time direction of a frame group corresponding to a first period including the frame;

a total stillness amount calculation unit that calculates, for each frame, a value based on the number of total motion vectors each having a magnitude of not more than a first predetermined value as a total stillness amount; and

an extraction unit that extracts, as the moving image data of the desired scene, moving image data composed of a frame group including a frame having the calculated total stillness amount of not less than a first threshold at a rate not less than a predetermined rate.

The present invention in its second aspect provides an image processing method for extracting moving image data of a desired scene from inputted moving image data, comprising the steps of:

detecting a motion vector from each frame of the inputted moving image data, for each block obtained by dividing the frame;

calculating, for each block of the frame, a total motion vector being a total value of the motion vectors in a time direction of a frame group corresponding to a first period including the frame;

calculating, for each frame, a value based on the number of total motion vectors each having a magnitude of not more than a first predetermined value as a total stillness amount; and

extracting, as the moving image data of the desired scene, moving image data composed of a frame group including a frame having the calculated total stillness amount of not less than a first threshold at a rate not less than a predetermined rate.

The present invention in its third aspect provides an image processing apparatus for extracting moving image data of a desired scene from inputted moving image data, comprising:

a motion vector detection unit that detects a motion vector from each frame of the inputted moving image data, for each block obtained by dividing the frame;

a total motion vector calculation unit that calculates, for each frame group corresponding to a predetermined period and for each block, a total motion vector being a total value of the motion vectors in a time direction of the frame group; and

an extraction unit that extracts, as the moving image data of the desired scene, moving image data composed of a frame group that includes, at a rate not less than a predetermined rate, the frame group which corresponds to the predetermined period and in which the number of total motion vectors each having a magnitude of not more than a first predetermined value is not less than a first threshold.

According to the present invention, it is possible to extract only the moving image data of the scene capable of giving high realistic sensation to viewers from the inputted moving image data.

Further features of the present invention will become apparent from the following description of exemplary embodiments with reference to the attached drawings.

### BRIEF DESCRIPTION OF THE DRAWINGS

FIG. 1 is a block diagram showing an example of a functional configuration of an image processing apparatus according to a first embodiment;

FIG. 2 is a view showing an example of each of total motion vector histograms;

FIG. 3 is a view showing an example of each of per-frame motion vector histograms;

FIG. 4 is a flowchart showing an example of a flow of processing of a viewing target moving image judgment unit;

FIGS. 5A and 5B are views each showing an example of a change in total stillness amount with time;

FIG. 6 is a view showing an example of a change in per-frame movement amount with time;

FIG. 7 is a view showing an example of each of total motion vector histograms;

FIG. 8 is a view showing an example of a change in the fluctuation amount of an APL with time;

FIG. 9 is a block diagram showing an example of a functional configuration of an image processing apparatus according to a second embodiment;

FIG. 10 is a view showing an example of a change in total stillness amount with time; and

FIG. 11 is a view showing an example of a change in total stillness amount with time.

### DESCRIPTION OF THE EMBODIMENTS

### First Embodiment

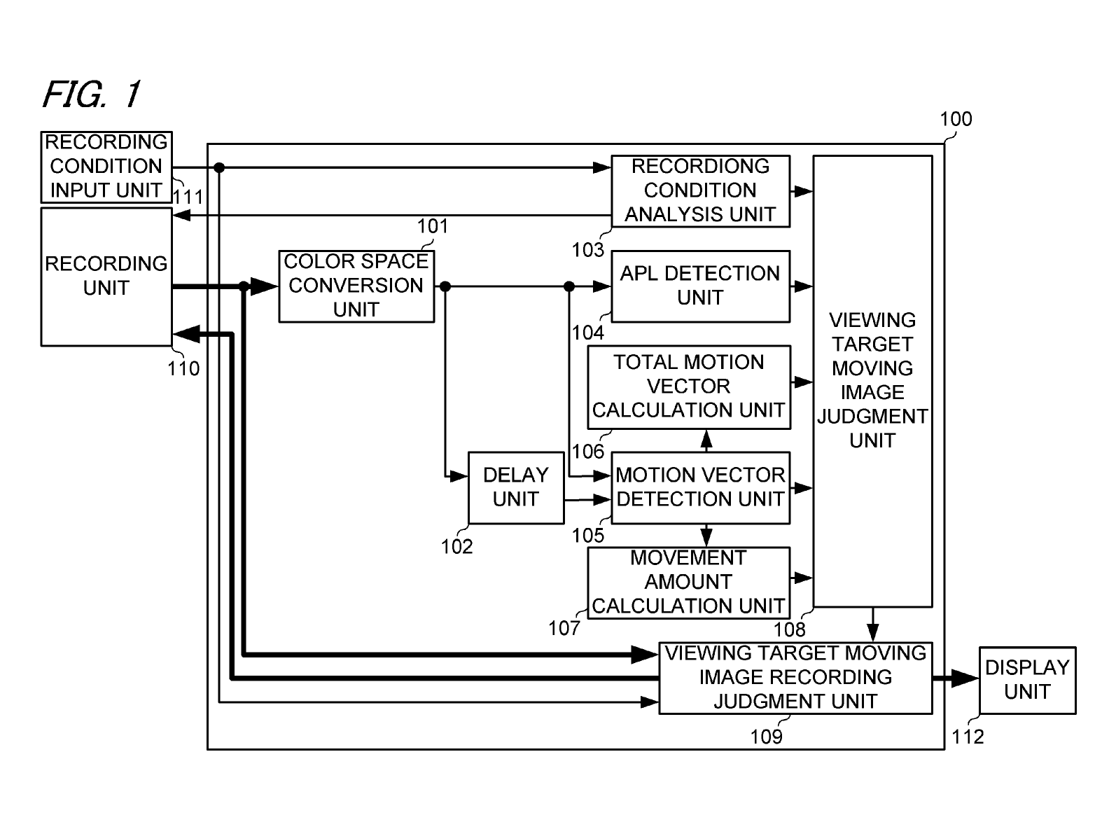

A description is given hereinbelow of an image processing apparatus according to a first embodiment of the present invention and an image processing method executed by the image processing apparatus by using FIGS. 1 to 8.

FIG. 1 is a block diagram showing an example of a functional configuration of the image processing apparatus according to the first embodiment.

An image processing apparatus 100 has a color space conversion unit 101, a delay unit 102, a recording condition analysis unit 103, an APL detection unit 104, a motion vector detection unit 105, a total motion vector calculation unit 106, a movement amount calculation unit 107, a viewing target moving image judgment unit 108, and a viewing target moving image recording judgment unit 109. These components are connected to each other with buses. The image processing apparatus 100 is capable of wireless or wired communication with a recording unit 110, a recording condition input unit 111, and a display unit 112.

The recording unit 110 is a recording apparatus for recording moving image data in a recording medium such as an optical disk, a magnetic disk, or a memory card. The recording unit 110 is, e.g., a PC, a DVD recorder, an HDD recorder, or a digital video camera. The recording medium may be fixed to the recording unit 110, or may be detachable from the recording unit 110.

The moving image data is compressed moving image data such as MPEG data or the like, or RAW moving image data. The RAW moving image data is moving image data obtained from a CCD (Charge Coupled Device) sensor or a CMOS (Complementary Metal Oxide Semiconductor) sensor.

In the present embodiment, to the image processing apparatus, the moving image data recorded in the recording medium (the moving image data recorded by the recording unit 110 or other apparatuses) is inputted. Subsequently, in accordance with recording conditions inputted by a user, moving image data of a viewing target moving image scene capable of giving high realistic sensation to viewers is extracted as moving image data of a desired scene from the inputted moving image data.

A description is given hereinbelow of individual functions of the image processing apparatus according to the processing flow of the image processing apparatus according to the present embodiment.

First, recording conditions are inputted to the image processing apparatus 100 from the recording condition input unit 111. The recording condition input unit 111 is a remote controller or the like. Specifically, the user operates the recording condition input unit 111, and moving image data (target moving image data), which is a target of extracting of moving image data of a viewing target moving image scene, is selected from moving image data recorded in the recording unit 110 (the recording medium). In addition, a time length of the moving image data of the viewing target moving image scene to be extracted (a time length of the viewing target moving image scene), the number thereof (the number of viewing target moving image scenes), and a recording method are also selected. With this, information such as the target moving image data, the time length of the viewing target moving image scene, the number of viewing target moving image scenes, and the recording method is inputted as the recording conditions.

The recording condition analysis unit 103 analyzes the inputted recording conditions, controls reading of the moving image data from the recording unit 110, and transmits the analyzed recording conditions to the viewing target moving image judgment unit 108.

The moving image data selected by the user is read from the recording unit 110, and is inputted to the image processing apparatus 100 (specifically the color space conversion unit 101).

The color space conversion unit 101 converts the inputted moving image data into a brightness signal (Y) and a color difference signal (Cb/Cr) by a color matrix calculation when the inputted moving image data is RGB data. On the other hand, when the inputted moving image data is YCbCr data, the color space conversion unit 101 outputs the inputted moving image data to the subsequent stage without any processing. The brightness signal (Y) is used to detect an APL (Average Picture Level) and a motion vector.

The moving image data outputted from the color space conversion unit 101 is delayed by a period corresponding to one frame in the delay unit 102 in order to detect the motion vector from the difference in the moving image data between temporally continuous frames.

The APL detection unit 104 extracts a brightness feature amount for each frame by using the brightness signal (Y) of the moving image data (a feature amount extraction unit). In the present embodiment, it is assumed that the APL is extracted as the brightness feature amount. Note that the brightness feature amount may be the minimum value, the maximum value, or the mode in the brightness level.

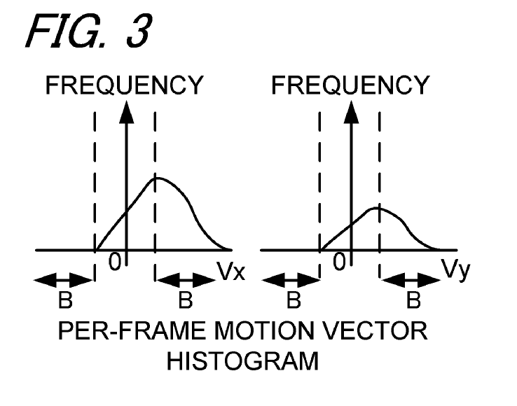

The motion vector detection unit 105 detects the motion vector from the inputted moving image data (a motion vector detection unit). In the present embodiment, each frame of the inputted moving image data is divided into a plurality of blocks, and the motion vector is detected for each block. Specifically, by using the brightness signal (Y) of the present frame and the brightness signal (Y) of the frame immediately previous to the present frame which has been delayed in the delay unit 102, the motion vector is detected for each block of the present frame. The detected motion vector is stored in an SRAM or a frame memory which is not shown. The motion vector is detected by using a typical method such as a method in which the motion vector is detected by dividing an image of a frame into a plurality of blocks and determining the correlation between frames for each block (i.e., a block matching method), or the like. Subsequently, the motion vector detection unit 105 produces a histogram of the motion vector (a per-frame motion vector histogram) for each frame (FIG. 3).

Note that the size of the block may be any size. The size thereof may be that of one pixel. That is, the motion vector may be detected for each pixel. For example, there may be used a method in which a predetermined search area is simply searched from upper left to lower right on a per pixel basis by a method called Full Search or Exhaustive Search, and the position having the smallest SAD (Sum of Absolute Difference) is determined as the motion vector. In addition, there may also be used a method called a step search in which rough search is performed first and the motion vector is searched for at gradually more specific levels, or a method called a spiral search in which the motion vector is searched for while a search area is gradually enlarged spirally.

Note that the motion vector may be detected for each block by the block matching method, and the motion vector of the block may be allocated to each pixel in the block. Further, the motion vector may be detected for each block by the block matching method, and the motion vector of the block may be allocated to a representative pixel of the block (e.g., a pixel present at the center of the block). In this case, when the motion vector of each pixel is referred to, the motion vector allocated to the representative pixel of the block may appropriately be referred to as the motion vector of each pixel in the block.

The total motion vector calculation unit 106 calculates a total motion vector being a total value of the motion vectors in a time direction of the frame group corresponding to a first period (a total motion vector calculation unit). In the present embodiment, for each block of the frame, the total value of the motion vectors in the time direction of the frame group corresponding to the first period including the frame is calculated as the total motion vector. Specifically, each block is subjected to processing in which the motion vectors of identical blocks of the frame group corresponding to the first period having the processing target frame as the reference are totalized, and the result of the totalization is allocated to the corresponding block of the processing target frame as the total motion vector. The first period is, e.g., a period which includes the predetermined number of frames (several frames to several tens of frames) including the processing target frame and frames previous thereto, frames subsequent thereto, or frames previous and subsequent thereto.

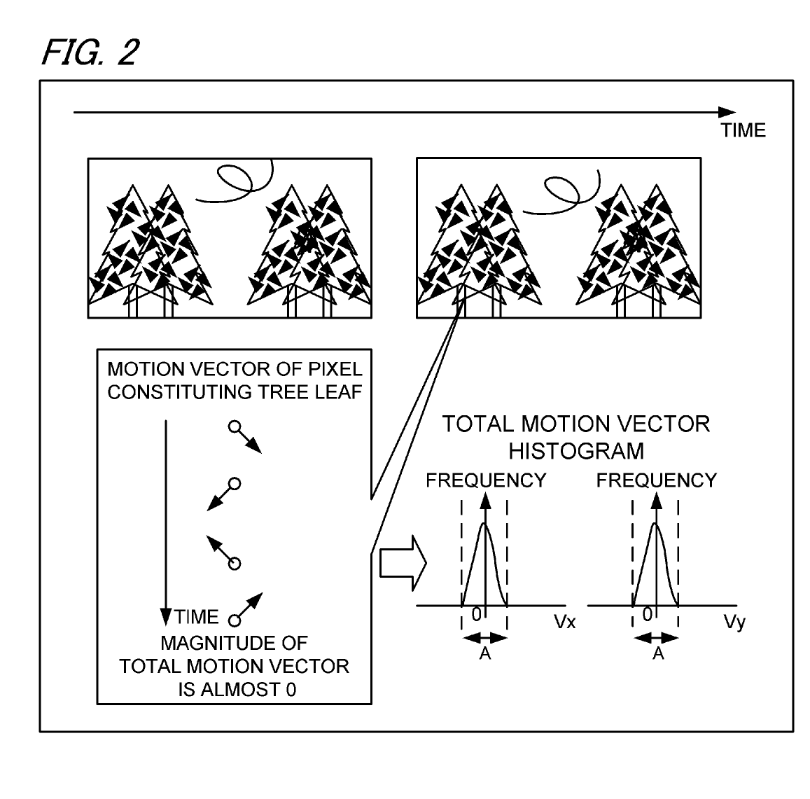

Then, the total motion vector calculation unit 106 produces the histogram of the total motion vector (the total motion vector histogram) for each frame. By totalizing the motion vectors corresponding to the first period, it is possible to exclude a movement having randomness or periodicity such as swing of leaves of a tree or shaking of the surface of the water. Specifically, as shown in FIG. 2, the total value of the motion vectors corresponding to the first period in a part where the movement has randomness or periodicity becomes almost 0. Note that the first period may be any period in which the movement having randomness or periodicity can be excluded, and is properly set by a manufacturer or a user.

The movement amount calculation unit 107 calculates, for each frame, a value representing the number of motion vectors each having a magnitude of not less than a predetermined value (not less than a second predetermined value) as a per-frame movement amount (a movement amount calculation unit). Specifically, among the motion vectors detected by the motion vector detection unit 105, the sum total of the number of motion vectors each having a magnitude of an x-direction (horizontal) component |Vx| of not less than the predetermined value and the number of motion vectors each having a magnitude of ay-direction (vertical) component |Vy| of not less than the predetermined value is calculated as the per-frame movement amount. That is, the total frequency of the motion vector belonging to ranges B of per-frame motion vector histograms shown in FIG. 3 is calculated as the per-frame movement amount. Note that the per-frame movement amount may be a value representing the ratio of the number of motion vectors each having the magnitude of not less than the predetermined value (not less than the second predetermined value) to the total number of motion vectors. The per-frame movement amount calculated in this manner (a statistic) takes a large value in a scene having a big movement (takes a small value in a scene having a small movement or in a still scene).

In the viewing target moving image judgment unit 108, it is judged whether or not the scene of the inputted moving image data is the viewing target moving image scene from the recording conditions, the APL, the total motion vector histogram, and the per-frame movement amount.

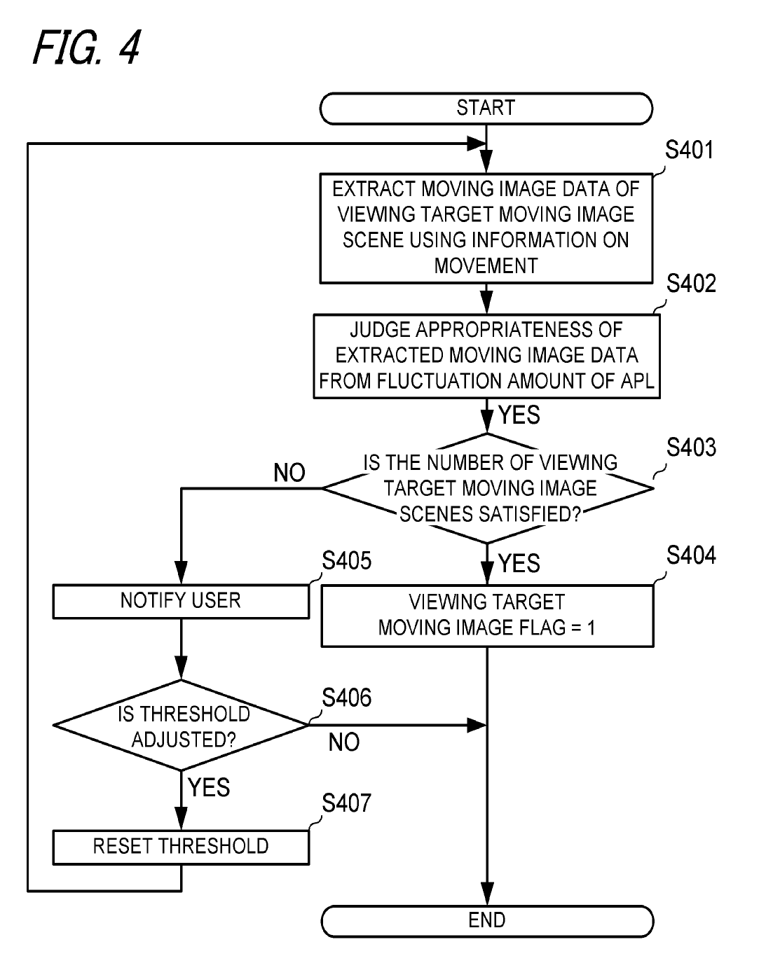

A description is given of the flow of the processing of the viewing target moving image judgment unit 108 by using a flowchart of FIG. 4 and FIGS. 5A to 8.

Note that it is assumed herein that the following recording conditions are inputted (set). The recording time denotes the time length of the target moving image data.

(Recording Conditions)

Target moving image data: moving image data X (recording time 30 seconds)

The number of viewing target moving image scenes: not less than 1 scene

Time length of viewing target moving image scene: 10 seconds

Recording method: addition of viewing target moving image flag to original moving image data

First, the viewing target moving image judgment unit 108 extracts moving image data of a viewing target moving image scene on the basis of information on a movement (the total motion vector histogram and the per-frame movement amount) from moving image data X (Step S401).

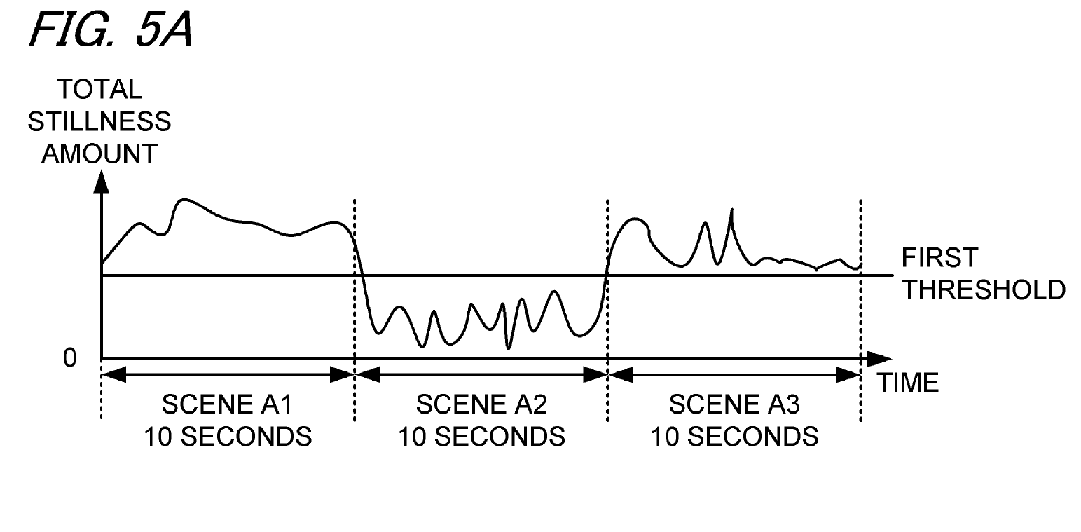

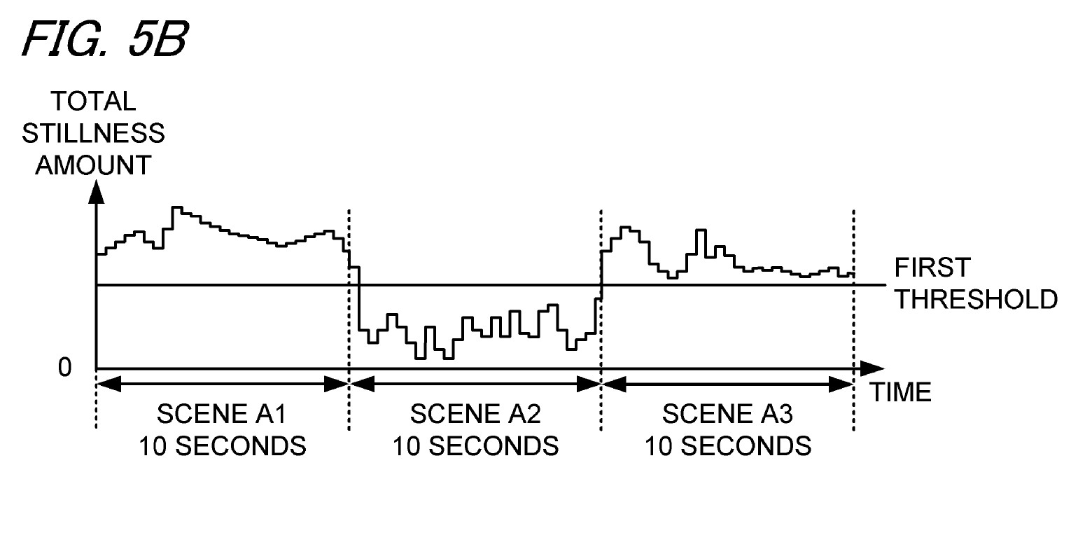

In Step S401, first, the viewing target moving image judgment unit 108 (a total stillness amount calculation unit) calculates, for each frame, a value representing the number of total motion vectors each having the magnitude of not more than a predetermined value (not more than a first predetermined value) as a total stillness amount. Specifically, among the total motion vectors, the total sum of the number of total motion vectors each having the magnitude of the x-direct on component |Vx| of not more than the predetermined value and the number of total motion vectors each having the magnitude of the y-direction component |Vy| of not more than the predetermined value is calculated as the total stillness amount. That is, the total frequency of the total motion vector belonging to regions A of FIG. 2 is calculated as the total stillness amount. Note that the total stillness amount may be a value representing the ratio of the number of total motion vectors each having the magnitude of not more than the predetermined value (not more than the first predetermined value) to the total number of motion vectors. The total stillness amount calculated in this manner (a statistic) takes a large value in a scene having a small movement (still scene). FIG. 5A is a graph having the vertical axis indicative of the total stillness amount and the horizontal axis indicative of time. The viewing target moving image judgment unit 108 performs scanning for the total stillness amount on the basis of the time length of the viewing target moving image scene (a second period) which is longer than the first period described above. Subsequently, the viewing target moving image judgment unit 108 (an extraction unit) extracts the moving image data composed of the frame group which corresponds to the second period and includes the frame having the total stillness amount of not less than a first threshold at a rate not less than a predetermined rate (a first rate) as the moving image data of the viewing target moving image scene. That is, the moving image data including a large number of parts each having a small movement is extracted as the moving image data of the viewing target moving image scene. In the present embodiment, it is assumed that the moving image data composed of the group of the frames each having the total stillness amount of not less than the first threshold is extracted as the moving image data of the viewing target moving image scene.

In the example of FIG. 5A, the moving image data of a scene A1 and a scene A3 is extracted as the moving image data of the viewing target moving image scene. The first threshold may be any value with which it can be judged whether the total stillness amount is appropriate as the stillness amount of the viewing target moving image scene, and is properly set by the manufacturer or the user.

Note that, although the time length of the viewing target moving image scene to be extracted is fixed (the length of the second period) in the present embodiment, the time length of the viewing target moving image scene may be changed. For example, after the scene composed of the frame group which includes the frame having the total stillness amount of not less than the first threshold at the rate not less than the first rate is extracted by the above-described method, the time length of the detected scene may be increased such that the frame having the total stillness amount of not less than the first threshold is included at the first rate.

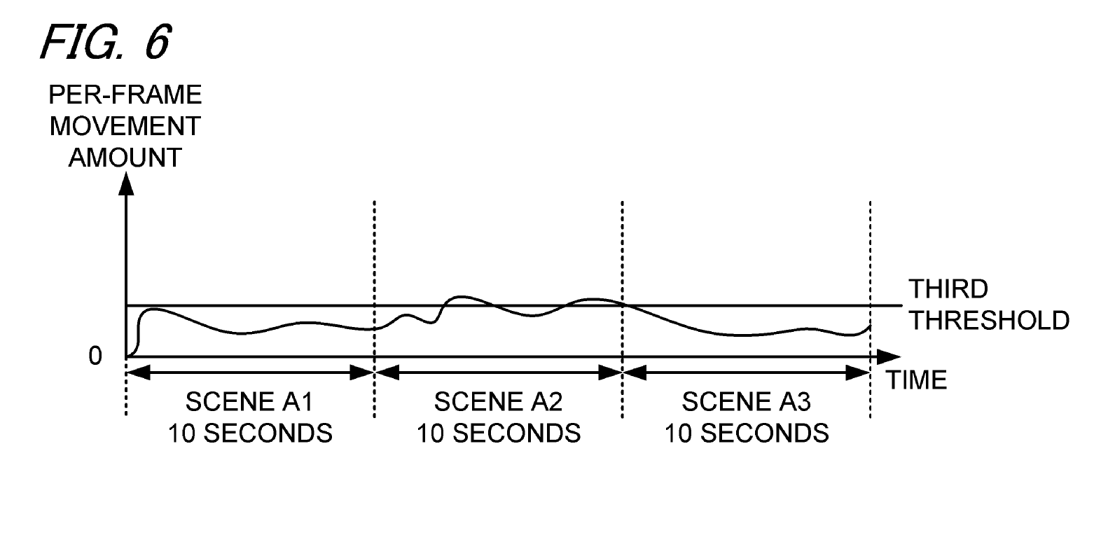

Next, the viewing target moving image judgment unit 108 judges the appropriateness of the extracted moving image data (the moving image data of the scenes A1 and A3) as the moving image data of the viewing target moving image scene from the per-frame movement amount. FIG. 6 is a graph having the vertical axis indicative of the per-frame movement amount and the horizontal axis indicative of time. The viewing target moving image judgment unit 108 narrows the moving image data of the viewing target scene to the moving image data composed of the frame group including the frame having the per-frame movement amount of not more than a third threshold at a rate not less than a predetermined rate (a second rate), out of the extracted moving image data (the moving image data of the scenes A1 and A3). In the present embodiment, it is assumed that the moving image data of the viewing target moving image scene is narrowed to the moving image data composed of the group of the frames each having the per-frame movement amount of not more than the third threshold. With this, the moving image data including a large number of parts each having a big movement is excluded from the moving image data of the viewing target moving image scene.

A periodic but big movement is not reflected in the total motion vector. Accordingly, the moving image data including a large number of such movements, e.g., the moving image data of a scene where a pendulum of a clock is zoomed in on may be judged as the moving image data of the viewing target moving image scene when only the judgment using the total motion vector is made. Such moving image data cannot give high realistic sensation to viewers, and hence such moving image data is preferably excluded from the moving image data of the viewing target moving image scene. By the present processing, such moving image data can be excluded from the moving image data of the viewing target moving image scene.

In the example of FIG. 6, the moving image data of scenes A1 and A3 is the moving image data composed of the group of the frames each having the per-frame movement amount of not more than the third threshold, and hence the moving image data is judged to be appropriate as the moving image data of the viewing target moving image scene, and is not excluded. The third threshold may be any value with which it can be judged whether or not the per-frame movement amount is appropriate as the per-frame movement amount of the viewing target moving image scene, and is properly set by the manufacturer or the user.

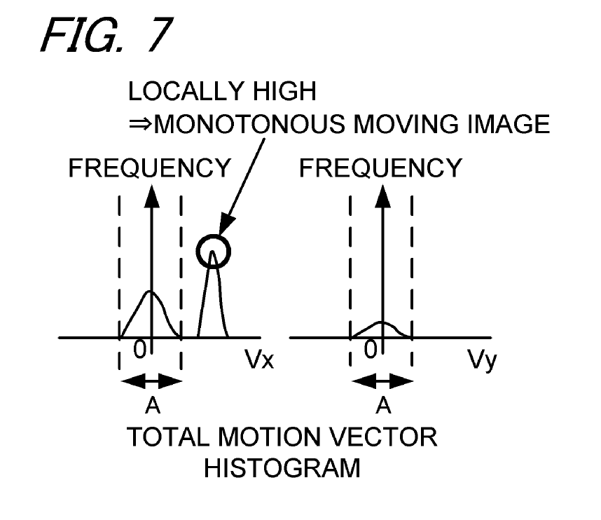

Note that it may be judged whether or not the moving image data of a scene A2, which has not been extracted as the moving image data of the viewing target moving image scene in Step S401, is determined as the moving image data of the viewing target moving image scene. For example, there are cases where the moving image data in which a vehicle or a person is moving in one direction is not extracted by the processing of Step S401. When an object is moving in one direction, in many cases, each of the total motion vector histograms exhibits the distribution shown in FIG. 7 (the distribution in which the frequency is locally high). Consequently, the total motion vector histogram may be analyzed, and the moving image data including the frame in which the frequency is locally high in a certain total motion vector at a rate higher not less than a predetermined rate may be further extracted as the viewing target moving image data. In other words, the moving image data composed of the frame group which corresponds to the second period and includes, at a rate not less than a predetermined rate, the frame in which the vectors oriented in a certain direction and having a certain magnitude larger than the first predetermined value are concentratively present as the total motion vector may be further extracted as the moving image data of the viewing target moving image scene. The judgment of whether or not the monotonous moving image data in which an object is moving in one direction is determined as the moving image data of the viewing target moving image scene may be made switchable by the user using the recording condition input unit 111. It is assumed herein that the moving image data of the scene A2 has not been extracted as the moving image data of the viewing target moving image scene. Note that a method of judging whether or not the frequency is locally high may be any method. For example, when the frequency of the value of the total motion vector having a predetermined width is higher than the frequencies of the total motion vectors previous and subsequent to the above total motion vector by a predetermined threshold, it can be judged that the frequency is locally high.

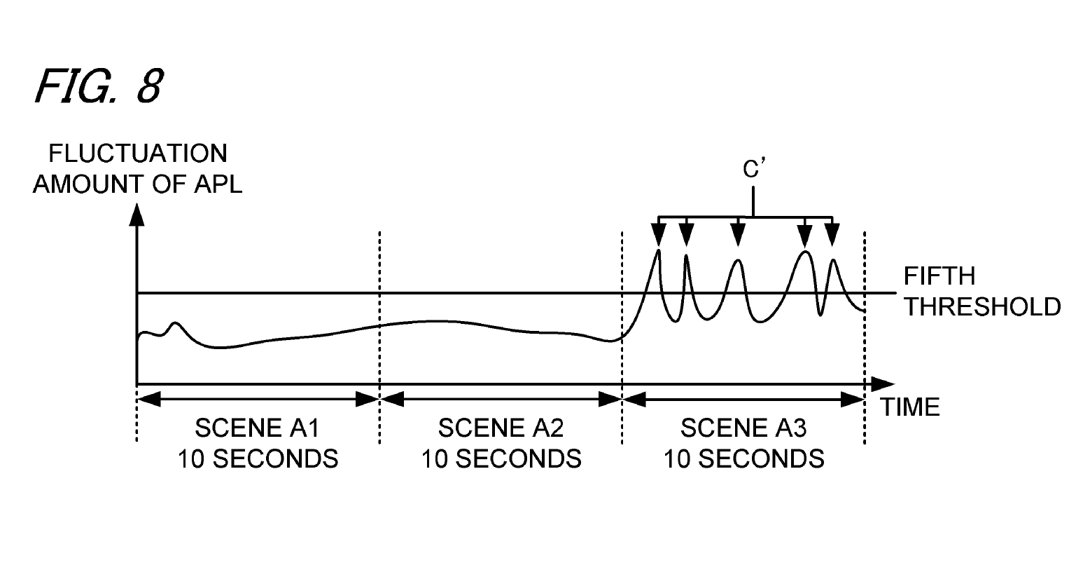

Next, the viewing target moving image judgment unit 108 calculates a fluctuation amount of the brightness feature amount (the APL) extracted by the APL detection unit 104 between frames. Subsequently, from the calculated fluctuation amount of the APL, the appropriateness of the extracted moving image data (in the present embodiment, the moving image data of the scene A1 and A3 extracted based on the total stillness amount and the per-frame movement amount) as the moving image data of the viewing target moving image scene is further judged (Step S402). The fluctuation amount of the APL is, e.g., the amount of a change in the APL from the immediately previous frame, or a gradient of a linear function obtained by performing least square approximation on the change in the APL with time during a predetermined period including the processing target (fluctuation amount calculation target) frame. FIG. 8 is a graph having the vertical axis indicative of the fluctuation amount of the APL and the horizontal axis indicative of time. The viewing target moving image judgment unit 108 narrows the moving image data of the viewing target moving image scene to the moving image data composed of the frame group including the frame having the fluctuation amount of the APL between frames of not less than a fifth threshold at a rate not less than a predetermined rate (a third rate), out of the extracted moving image data. In the present embodiment, it is assumed that the moving image data of the viewing target moving image scene is narrowed to the moving image data composed of the group of the frames each having the fluctuation amount of not less than the fifth threshold. With this, the moving image data having a significant change in brightness value between frames is excluded from the moving image data of the viewing target moving image scene.

The moving image data having the significant change in brightness value between frames such as the moving image data of a scene in which a strobe light flashes at short intervals may be judged as the moving image data of the viewing target moving image scene when only the processing of Step S401 is performed. Such moving image data cannot give high realistic sensation to viewers, and hence such moving image data is preferably excluded from the moving image data of the viewing target moving image scene. By the present processing, such moving image data can be excluded from the moving image data of the viewing target moving image scene.

In the example of FIG. 8, the moving image data of a scene A3 includes frames each having the fluctuation amount of the APL of more than the fifth threshold at times indicated by a reference C′. As a result, the moving image data of the scene A3 is judged to be inappropriate as the moving image data of the viewing target moving image scene to be excluded, and the moving image data of a scene A1 is determined as the moving image data of the viewing target moving image scene. However, Step S402 is not essential, and the processing of Step S402 may be omitted.

Subsequently, the viewing target moving image judgment unit 108 judges whether or not the number of moving image data items of the viewing target moving image scenes extracted (determined) in Step S402 satisfies the number of viewing target moving image scenes included in the recording conditions (Step S403). When the number is satisfied (Step S403: YES), the flow advances to Step S404 and, when the number is not satisfied (Step S403: NO), the flow advances to Step S405.

In Step S404, the viewing target moving image judgment unit 108 sets a viewing target moving image flag of 1 in the extracted moving image data of the viewing target moving image scene (the scene A1). Then, the viewing target moving image judgment unit 108 outputs the extracted moving image data of the viewing target moving image scene and the viewing target moving image flag thereof to the viewing target moving image recording judgment unit 109, and ends the processing of the present flow.

In Step S405, the viewing target moving image judgment unit 108 performs processing for notifying the user that the moving image data of the viewing target moving image scene has not been extracted.

After Step S405, the viewing target moving image judgment unit 108 performs processing for asking the user whether or not the first, third, or fifth threshold is adjusted (Step S406). When at least one of the first, third, and fifth thresholds is adjusted (Step S406: YES), the flow advances to Step S407 and, when none of them is adjusted (Step S406: NO), the processing of the present flow is ended.

In Step S407, the viewing target moving image judgment unit 108 resets the first, third, or fifth threshold. Subsequently, the processing from Step S401 is re-executed.

Note that, in Step S407, in accordance with the instruction of the user, the number of viewing target moving image scenes and the time length of the viewing target moving image scene may be reset. In addition, the first to third rates may also be reset. For example, when the time length of the viewing target moving image scene is set to 10 seconds, and each of the first to third rates is set to 80%, the moving image data which has the time length of 10 seconds and includes the frame appropriate as the frame of the viewing target moving image scene corresponding to not less than 8 seconds is determined as the moving image data of the viewing target moving image scene. Note that, in the present embodiment, the frame appropriate as the frame of the viewing target moving image scene is a frame which has the total stillness amount of not less than the first threshold, the per-frame movement amount of not more than the third threshold, and the fluctuation amount of the brightness feature amount between frames of not more than the fifth threshold.

The viewing target moving image recording judgment unit 109 stores the moving image data (the extracted moving image data of the viewing target moving image scene) having the viewing target moving image flag of 1 set in the viewing target moving image judgment unit 108 in a recording medium of the recording unit 110 by the recording method included in the recording conditions. In the present embodiment, since the recording method is “addition of viewing target moving image flag to original moving image data”, the original moving image data stored in the recording unit 110 is recorded in association with the viewing target moving image flag of “1” during the period of the moving image data of the viewing target moving image scene.

Note that other recording methods include a method in which only the moving image data having the viewing target moving image flag of 1 is recorded as another moving image data different from the original moving image data, and a method in which after the moving image data other than the moving image data extracted as the viewing target moving image scene is deleted from the original moving image data, the extracted moving image data thereof is recorded. In addition, the feature amounts such as the per-frame movement amount, the total stillness amount, and the fluctuation amount of the APL may be stored in association with the original moving image data, and then the extraction of the moving image data of the viewing target moving image scene may be performed by using these data items.

As has been described above, according to the present embodiment, it is possible to extract only the moving image data composed of the frame group including the frame having the total stillness amount of not less than the first threshold at the rate not less than the predetermined rate as the moving image data of the viewing target moving image scene. The moving image data composed of the frame group including the frame having the total stillness amount of not less than the first threshold at the rate not less than the predetermined rate is moving image data having a small movement or moving image data including a large number of monotonous movements such as a movement with randomness or periodicity. Such moving image data is capable of giving high realistic sensation to viewers. That is, according to the present embodiment, it is possible to extract only the moving image data of the scene capable of giving high realistic sensation to viewers from the inputted moving image data.

In addition, moving image data having a large number of periodic but big movements is not capable of giving high realistic sensation to viewers. In the present embodiment, the moving image data of the viewing target moving image scene is narrowed to the moving image data composed of the frame group including the frame having the per-frame movement amount of not more than the third threshold at the rate not less than the predetermined rate, out of the extracted moving image data. With this, it is possible to exclude the moving image data having a large number of periodic but big movements from the moving image data of the viewing target moving image scene, and extract only the moving image data of the scene capable of giving high realistic sensation to viewers from the inputted moving image data with further enhanced precision.

Further, the moving image data having a significant change in brightness value between frames is not capable of giving high realistic sensation to viewers. In the present embodiment, the moving image data of the viewing target moving image scene is narrowed to the moving image data composed of the frame group including the frame having the fluctuation amount in brightness feature amount between frames of not more than the fifth threshold at the rate not less than the predetermined rate, out of the extracted moving image data. With this, it is possible to exclude the moving image data having the significant change in brightness value between frames from the moving image data of the viewing target moving image scene, and extract only the moving image data of the scene capable of giving high realistic sensation to viewers from the inputted moving image data with further enhanced precision.

In the present embodiment, although the total motion vector of each block is calculated for each frame, the total motion vector of each block may also be calculated for each frame group (several frames to several tens of frames) corresponding to a predetermined period (the first period). That is, for each frame group corresponding to the predetermined period and each block, the total motion vector as the total value of the motion vectors in the time direction of the frame group may also be calculated. In this case, the total stillness amount may also be calculated for each frame group corresponding to the first period. Specifically, as shown in FIG. 5B, for each frame group corresponding to the first period, the value (the number of total motion vectors each having the magnitude of not more than the predetermined value, or the value obtained by dividing the number of total motion vectors each having the magnitude of not more than the predetermined value by the total number of total motion vectors) based on the number of total motion vectors each having the magnitude of not more than the predetermined value (not more than the first predetermined value) may be calculated as the total stillness amount. Subsequently, the moving image data corresponding to a second period (e.g., 10 seconds) including the period having the total stillness amount of not less than the first threshold (the period of the frame group corresponding to the first period) at a rate not less than a predetermined rate may be extracted as the moving image data of the viewing target moving image scene.

Note that the total motion vector of each block may be calculated for each frame, and the total stillness amount may be calculated for each frame group corresponding to the first period.

Note that, without calculating the total stillness amount, the moving image data composed of the frame group including the frame having the number of total motion vectors each having the magnitude of not more than the predetermined value of not less than the first threshold (or the frame group corresponding to the first period described above) at the rate not less than the predetermined rate may be extracted as the moving image data of the viewing target moving image scene.

In the present embodiment, although the brightness feature amount is used as the feature amount, another feature amount such as a color feature amount or a shape feature amount of an image may also be used instead of the brightness feature amount. Even such configuration can obtain the operation and effect similar to the operation and effect described above. In addition, a plurality of feature amounts may also be used. For example, to the processing of the present embodiment, processing for narrowing the moving image data of the viewing target moving image scene based on the fluctuation amount of the shape feature amount may be further added. By having such configuration, it is possible to extract only the moving image data of the scene capable of giving high realistic sensation to viewers from the inputted moving image data with further enhanced precision.

In the present embodiment, although the recording condition are selected and inputted by the operation of the user, the recording conditions may be fixed values pre-recorded in the image processing apparatus. Alternatively, the recording conditions may be preset for each original moving image data (the target moving image data) (may be added to the target moving image data).

In the present embodiment, as the histogram of the motion vector (the total motion vector), the histogram of each of the x-direction component and the y-direction component of the motion vector is produced, the histogram is not limited to the histogram described above. The histogram may also be a two-dimensional histogram. In addition, in the present embodiment, although the motion vector is divided into a plurality of components and the values of the individual components are compared with the threshold, the comparison method is not limited to the comparison method described above. The magnitude of the motion vector may be compared with the threshold without dividing the mot ion vector into the plurality of components. Further, the histogram may not be produced. For example, without producing the total motion vector histogram, the total stillness amount may be calculated from the value of each total motion vector.

Note that the first to third rates may be the same rate or different rates.

### Second Embodiment

A description is given hereinbelow of an image processing apparatus according to a second embodiment of the present invention and an image processing method executed by the image processing apparatus by using FIGS. 1, 2, 6, and 9 to 12.

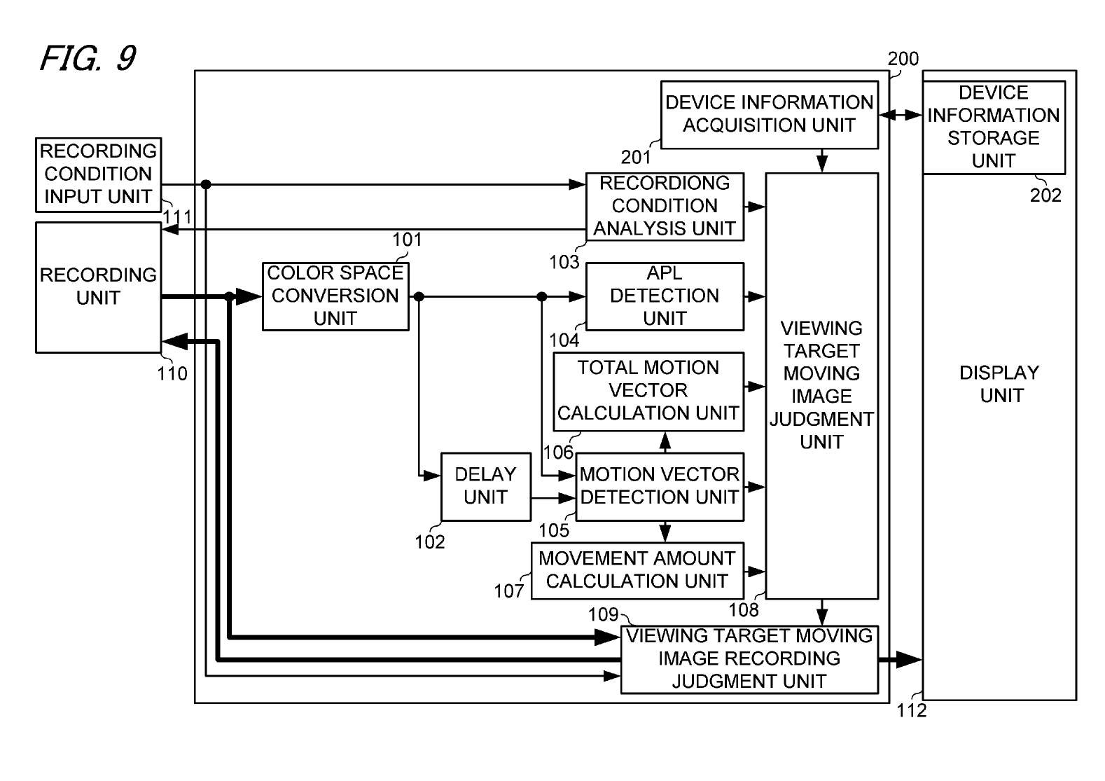

FIG. 9 is a block diagram showing an example of a functional configuration of the image processing apparatus according to the second embodiment.

An image processing apparatus 200 further includes a device information acquisition unit 201 in addition to the configuration of the first embodiment (FIG. 1). In addition, in the display unit 112 (the display apparatus for displaying the moving image based on the extracted moving image data of the viewing target moving image scene) capable of wireless or wired communication with the image processing apparatus 200, a device information storage unit 202 is provided. The other components are the same as those of FIG. 1 so that the same components are designated by the same reference numerals as in FIG. 1. Hereinbelow, points different from the first embodiment are described.

The device information acquisition unit 201 acquires device information from the device information storage unit 202, and outputs the device information to the viewing target moving image judgment unit 108 (an acquisition unit).

The device information storage unit 202 is a recording medium for storing the device information on the display unit 112 such as an EDID (Extended Display Identification Data) ROM or the like. Note that the device information storage unit 202 may appropriately store the device information, and is not limited to the EDID ROM. In the present embodiment, it is assumed that, in the device information storage unit 202, information indicating a driving method, a display frame rate (including a frame rate conversion method), and a display method of the display unit 112 (a display apparatus, a display panel) is stored as the device information. The display frame rate is a frame rate of a moving image to be displayed of the display unit 112.

In the present embodiment, the viewing target moving image judgment unit 108 changes the value of the first threshold on the basis of the inputted device information. In addition, the viewing target moving image judgment unit 108 further uses the second threshold when the extraction processing of the moving image data of the viewing target moving image scene using the total stillness amount is performed.

First, a description is given of a method of changing the first threshold on the basis of the device information.

When the driving method of the display unit 112 is a holding-type driving method, there is a possibility that, when a moving image of leaves of a tree swayed by a strong wind is displayed, the image is blurred. Such blurring results in a reduction of the realistic sensation, and the moving image data generating such blurring is not appropriate as the moving image data of the viewing target moving image scene. Accordingly, in the present embodiment, the viewing target moving image judgment unit 108 judges whether the driving method of the display unit 112 is an impulse-type driving method or the holding-type driving method from the inputted (acquired) device information. Subsequently, the viewing target moving image judgment unit 108 changes the first threshold according to the judgment result.

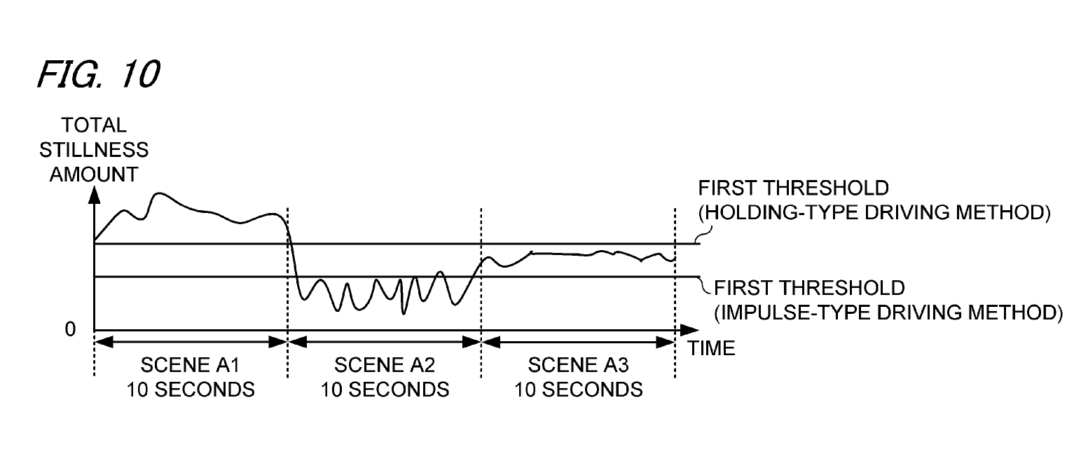

FIG. 10 is a graph having the vertical axis indicative of the total stillness amount and the horizontal axis indicative of time. The display unit of the impulse-type driving method is characterized in its resistance to blurring even when the moving image to be displayed has some movements. Consequently, in the present embodiment, when the driving method of the display unit 112 is the impulse-type driving method, the viewing target moving image judgment unit 108 sets the first threshold to a value lower than a value set when the driving method is the holding-type driving method. The lower value is set as the first threshold when the driving method of the display unit 112 is the impulse-type driving method, whereby it is possible to extract the moving image data having some movements as the moving image data of the viewing target moving image scene. In the example of FIG. 10, when the driving method of the display unit 112 is the impulse-type driving method, the moving image data of scenes A1 and A3 is extracted as the moving image data of the viewing target moving image scene.

On the other hand, the display apparatus of the holding-type driving method is characterized in its susceptibility to blurring when the moving image to be displayed has movements as compared with the display apparatus of the impulse-type driving method. In the present embodiment, when the driving method of the display unit 112 is the holding-type driving method, the higher value is set as the first threshold, whereby it is possible to extract only the moving image data without possibility of occurrence of the blurring as the moving image data of the viewing target moving image scene. In the example of FIG. 10, when the driving method of the display unit 112 is the holding-type driving method, only the moving image data of the scene A1 is extracted as the moving image data of the viewing target moving image scene.

In addition, as the display frame rate becomes higher, the blurring is less likely to occur. As a result, the display frame rate of the display unit 112 may be determined from the inputted device information. Further, as the display frame rate of the display unit 112 becomes higher, a lower value may be set as the first threshold. Even such configuration can obtain the operation and effect similar to those described above.

Furthermore, in a liquid crystal display, by adopting, as the display method, a black insertion display method in which a black image is inserted between frames of a moving image based on inputted moving image data and the moving image is displayed, it is possible to reduce the blurring. Consequently, from the inputted device information, it may be judged whether or not the display method of the display unit 112 is the black insertion display method. In addition, when the display method of the display unit 112 is the black insertion display method, a value lower than a value set when the display method is not the black insertion display method may be set as the first threshold. Even such configuration can achieve the operation and effect similar to those described above.

Moreover, by changing the first threshold by combining the above-described information items, it becomes possible to extract more appropriate moving image data as the moving image data of the viewing target moving image scene.

Next, a description is given of a method of performing the extraction processing of the moving image data of the viewing target moving image scene using the total stillness amount and additionally using the second threshold.

In the first embodiment, in the extraction processing using the total stillness amount, there are cases where data of a moving image with no movement (a moving image which is almost a still image) is extracted as the moving image data of the viewing target moving image scene. Viewers feel higher realistic sensation from the moving image with any movement than from the moving image with no movement. Accordingly, in the present embodiment, the second threshold is used as the upper limit in the judgment of whether or not the total stillness amount is appropriate as the stillness amount of the viewing target moving image scene, whereby the extraction of the data of the moving image with no movement (the moving image which is almost the still image) as the moving image data of the viewing target moving image scene is prevented.

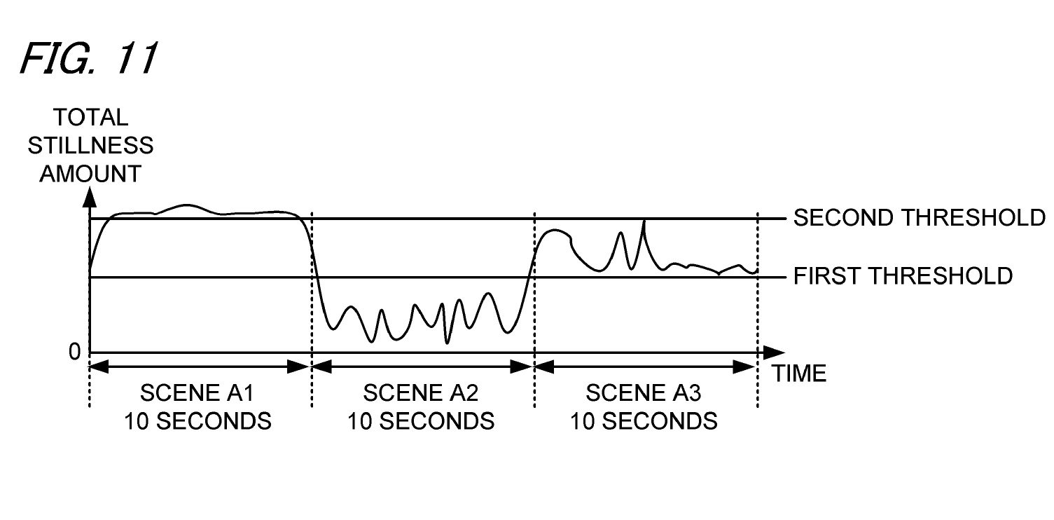

FIG. 11 is a graph having the vertical axis indicative of the total stillness amount and the horizontal axis indicative of time.

In the present embodiment, the second threshold is inputted to the image processing apparatus through the recording condition input unit 111 by the operation of the user. The second threshold may be inputted (set) at the timing, e.g., before Step S401 or of Step S406 of FIG. 4. Note that the second threshold may be pre-stored in the image processing apparatus, or may be added to the target moving image data.

In Step S401 of FIG. 4, when the extraction processing using the total stillness amount is performed, the second threshold is used as the upper limit to the total stillness amount appropriate as the viewing target moving image scene. That is, in Step S401, the viewing target moving image judgment unit 108 extracts the moving image data composed of the frame group including the frame having the total stillness amount of not less than the first threshold and not more than the second threshold at the rate not less than the predetermined rate as the moving image data of the viewing target moving image scene. In the example of FIG. 11, although the moving image data of scenes A1 and A3 is extracted as the moving image data of the viewing target moving image scene in the configuration of the first embodiment, only the moving image data of a scene A3 is extracted as the moving image data of the viewing target moving image scene in the configuration of the second embodiment.

Other processing is the same as that of the first embodiment so that the description thereof is omitted.

The viewing target moving image recording judgment unit 109 stores the moving image data (the extracted moving image data of the viewing target moving image scene) having the viewing target moving image flag of 1 set by the viewing target moving image judgment unit 108 in the recording medium of the recording unit 110 by the recording method included in the recording conditions. In the present embodiment, the extracted moving image data is stored in association with at least one of information items such as the device information on the display unit 112, the recording condition used in the extraction, and the threshold. For example, the extracted moving image data is stored in association with the information item such as the driving method, the display frame rate, or the display method of the display unit 112.

As has been described above, according to the present embodiment, the value of the first threshold is changed on the basis of the device information. With this, it becomes possible to extract more appropriate moving image data as the moving image data of the viewing target moving image scene. That is, it is possible to extract only the moving image data of the scene capable of giving high realistic sensation to viewers from the inputted moving image data with higher precision than in the case where the first threshold is not changed on the basis of the device information.

In addition, according to the present embodiment, as the upper limit in the judgment of whether or not the total stillness amount is appropriate as the stillness amount of the viewing target moving image scene, the second threshold is used. With this, it is possible to prevent the extraction of the data of the moving image with no movement (the moving image which is almost the still image) as the moving image data of the viewing target moving image scene. Further, in the present embodiment, since the second threshold is inputted by the user, i.e., can be changed by the user, it is possible to determine the criteria of the judgment of whether or not the moving image data is determined as the moving image data of the viewing target moving image scene in accordance with the preference of the user. For example, it is possible to select whether or not the data of the moving image with no movement (almost the still image) is extracted as the moving image data of the viewing target moving image scene.

Furthermore, according to the present embodiment, the extracted moving image data is stored in association with at least one of the information items such as the device information, the recording condition, and the threshold. With this, when the moving image data of the viewing target moving image scene is extracted in another image processing apparatus, by extracting the moving image data by using the recorded information as a reference, it becomes possible to reduce an extraction time (a processing time). Moreover, when the conditions in the extraction (the device information, the recording condition, and the threshold) are the same, it becomes possible to display only the moving image data of the viewing target moving image scene in the display apparatus without performing the extraction processing.

Note that, in the present embodiment, although the value of the first threshold is changed on the basis of the device information, the third threshold described in the first embodiment may also be changed on the basis of the device information. Specifically, when the driving method of the display apparatus is the impulse-type driving method, a value higher than a value in the case of the holding-type driving method may be set as the third threshold. As the display frame rate of the display apparatus becomes higher, a higher value may be set as the third threshold. When the display method of the display apparatus is the black insertion display method, a value higher than a value set when the display method is not the black insertion display method may be set as the third threshold. Even such configuration can achieve the effect similar to the operation and effect described above.

Additionally, when the extraction processing (the narrowing processing) of the moving image data of the viewing target moving image scene using the total stillness amount is performed, the fourth threshold may be used as the lower limit in the judgment of whether or not the per-frame movement amount is appropriate as the per-frame movement amount of the viewing target moving image scene. That is, the moving image data of the viewing target moving image scene may be narrowed to the moving image data composed of the frame group including the frame having the per-frame movement amount of not less than the fourth threshold and not more than the third threshold at the rate not less than the predetermined rate, out of the extracted moving image data. With this, it is possible to obtain the operation and effect similar to the operation and effect obtained when the second threshold is used as the upper limit in the judgment of whether or not the total stillness amount is appropriate as the total stillness amount of the viewing target moving image scene.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-000672, filed on Jan. 5, 2011, and Japanese Patent Application No. 2011-241099, filed on Nov. 2, 2011, which are hereby incorporated by reference herein in their entirety.

What is claimed is:

1. An image processing apparatus for extracting moving image data of a desired scene from inputted moving image data, comprising:
a motion vector detection unit that detects a motion vector from each frame of the inputted moving image data, for each block obtained by dividing the frame;
a total motion vector calculation unit that calculates, for each block of the frame, a total motion vector being a total value of the motion vectors in a time direction of a frame group corresponding to a first period including the frame;
a total stillness amount calculation unit that calculates, for each frame, a value based on the number of total motion vectors each having a magnitude of not more than a first predetermined value as a total stillness amount; and
an extraction unit that extracts, as the moving image data of the desired scene, moving image data composed of a frame group including a frame having the calculated total stillness amount of not less than a first threshold at a rate not less than a predetermined rate.

2. The image processing apparatus according to claim 1, wherein the extraction unit extracts, as the moving image data of the desired scene, moving image data composed of a frame group corresponding to a second period longer than the first period based on the total stillness amount calculated by the total stillness amount calculation unit.

3. The image processing apparatus according to claim 1, wherein the extraction unit extracts, as the moving image data of the desired scene, moving image data composed of a frame group including a frame having the total stillness amount of not less than the first threshold and not more than a second threshold at a rate not less than a predetermined rate.

4. The image processing apparatus according to claim 1, further comprising:
a per-frame movement amount calculation unit that calculates, for each frame, a value based on the number of motion vectors each having a magnitude of not less than a second predetermined value as a per-frame movement amount, wherein
the extraction unit narrows the moving image data of the desired scene to moving image data composed of a frame group including a frame having the per-frame movement amount of not more than a third threshold at a rate not less than a predetermined rate, out of the extracted moving image data.

5. The image processing apparatus according to claim 4, wherein the extraction unit narrows the moving image data of the desired scene to moving image data composed of a frame group including a frame having the per-frame movement amount of not less than a fourth threshold and not more than the third threshold at a rate not less than a predetermined rate, out of the extracted moving image data.

6. The image processing apparatus according to claim 1, further comprising:
a feature amount extraction unit that extracts, for each frame, a brightness feature amount, a color feature amount or a shape feature amount, wherein
the extraction unit narrows the moving image data of the desired scene to moving image data composed of a frame group including a frame having a fluctuation amount, of the feature amount extracted by the feature amount extraction unit between the frames, of not more than a fifth threshold at a rate not less than a predetermined rate, out of the extracted moving image data.

7. The image processing apparatus according to claim 1, wherein the extraction unit further extracts, as the moving image data of the desired scene, moving image data composed of a frame group that includes, at a rate not less than a predetermined rate, a frame in which vectors oriented in a certain direction and having a certain magnitude larger than the first predetermined value are concentratively present as the total motion vector.

8. The image processing apparatus according to claim 1, further comprising:
an acquisition unit that acquires information indicating a driving method of a display apparatus for displaying a moving image based on the extracted moving image data of the desired scene, wherein
the extraction unit judges whether the driving method of the display apparatus is an impulse-type driving method or a holding-type driving method from the information acquired by the acquisition unit, and when the driving method of the display apparatus is the impulse-type driving method, the extraction unit sets the first threshold to a value lower than a value set when the driving method is the holding-type driving method.

9. The image processing apparatus according to claim 1, further comprising:
an acquisition unit that acquires information indicating a display frame rate being a frame rate of a moving image to be displayed, of a display apparatus for displaying the moving image based on the extracted moving image data of the desired scene, wherein
the extraction unit determines the display frame rate of the display apparatus from the information acquired by the acquisition unit, and sets the first threshold to a lower value as the display frame rate of the display apparatus becomes higher.

10. The image processing apparatus according to claim 1, further comprising:
an acquisition unit that acquires information indicating a display method of a display apparatus for displaying the moving image based on the extracted moving image data of the desired scene, wherein
the extraction unit judges, from the information acquired by the acquisition unit, whether or not the display method of the display apparatus is a black insertion display method in which a black image is inserted between frames of a moving image based on the inputted moving image data and the moving image is displayed, and when the display method of the display apparatus is the black insertion display method, the extraction unit sets the first threshold to a value lower than a value set when the display method is not the black insertion display method.

11. The image processing apparatus according to claim 1, wherein the motion vector detection unit divides each frame of the inputted moving image data into a plurality of the blocks and detects the motion vector for each block by a block matching method.

12. The image processing apparatus according to claim 1, wherein a size of the block corresponds to that of one pixel.

13. An image processing method for extracting moving image data of a desired scene from inputted moving image data, comprising the steps of:
detecting a motion vector from each frame of the inputted moving image data, for each block obtained by dividing the frame;
calculating, for each block of the frame, a total motion vector being a total value of the motion vectors in a time direction of a frame group corresponding to a first period including the frame;
calculating, for each frame, a value based on the number of total motion vectors each having a magnitude of not more than a first predetermined value as a total stillness amount; and
extracting, as the moving image data of the desired scene, moving image data composed of a frame group including a frame having the calculated total stillness amount of not less than a first threshold at a rate not less than a predetermined rate.

14. An image processing apparatus for extracting moving image data of a desired scene from inputted moving image data, comprising:
a motion vector detection unit that detects a motion vector from each frame of the inputted moving image data, for each block obtained by dividing the frame;
a total motion vector calculation unit that calculates, for each frame group corresponding to a predetermined period and for each block, a total motion vector being a total value of the motion vectors in a time direction of the frame group; and
an extraction unit that extracts, as the moving image data of the desired scene, moving image data composed of a frame group that includes, at a rate not less than a predetermined rate, the frame group which corresponds to the predetermined period and in which the number of total motion vectors each having a magnitude of not more than a first predetermined value is not less than a first threshold.
